(19) United States
(12) Patent Application Publication
(10) Pub. No.: US 2019/0336983 A1
(43) Pub. Date: Nov. 7, 2019

(54) Tiered Magnet Modular Collar

(71) Applicants: Anthony Short, Davis City, IA (US); Ronald Crabtree, Waukee, IA (US)

(72) Inventors: Anthony Short, Davis City, IA (US); Ronald Crabtree, Waukee, IA (US)

(21) Appl. No.: 16/237,910

(22) Filed: Jan. 2, 2019

Related U.S. Application Data
(60) Provisional application No. 62/665,170, filed on May 1, 2018.

(51) Int. Cl. B03C 1/035; B03C 1/26; E03C 1/26; E03C 1/186

(52) U.S. Cl. CPC B03C 1/035; E03C 1/186; E03C 1/26; B03C 1/26

(57) ABSTRACT

A tiered magnet modular collar designed to catch metallic objects inside a garbage disposal. The tiered magnet modular collar includes a plurality of tiered magnets, each tiered magnet having a first elongated member offset from a second elongated member. The first elongated member is atop a second elongated member via a connecting bar. The first elongated member has a first distal end opposite a first proximal end with a first interior surface opposite a first exterior surface. The second elongated member has a second distal end opposite a second proximal end with a second interior surface opposite a second exterior surface. The first elongated member and second elongated member have an arcuate shape such that the tiered magnets affix to one another in an annular manner. In this way, a user is able to affix the tiered magnet modular collar around a garbage disposal to catch metallic objects inserted therein.

### CROSS REFERENCE TO RELATED APPLICATIONS

This application claims the benefit of U.S. Provisional Application No. 62/665,170 filed on May 1, 2018. The above identified patent application is herein incorporated by reference in its entirety to provide continuity of disclosure.

### BACKGROUND OF THE INVENTION

The present invention relates to magnets. More specifically, the invention provides a plurality of tiered magnets having a first member and a second member offset from one another, wherein each tiered magnet is configured to affix to one another in an annular configuration.

Many people who clean dishes and utensils in their sink do so in a sink with a garbage disposal. Unfortunately, this often leads to the utensils falling into the garbage disposal prior to the garbage disposal being actuated, resulting in damage to the utensils. Additionally, the motor of the garbage disposal, as well as the blades and casing of the disposal, are typically damaged when an object is caught in the garbage disposal while actuated. Thus, an improved tiered magnet modular collar that can efficiently catch metallic objects inserted into a garbage disposal is desired.

### SUMMARY OF THE INVENTION

In view of the foregoing disadvantages inherent in the known types of magnetic collar now present in the known art, the present invention provides a tiered magnet modular collar wherein the same can be utilized for providing convenience for the user when desiring to catch metallic objects inserted into the garbage disposal.

The present system comprises a tiered magnet modular collar. The tiered magnet modular collar comprises a plurality of tiered magnets, each tiered magnet having a first elongated member offset from a second elongated member. The first elongated member is affixed to a second elongated member via a connecting bar disposed perpendicular therebetween. The first elongated member having a first distal end opposite a first proximal end with a first interior surface disposed opposite a first exterior surface. The second elongated member having a second distal end opposite a second proximal end with a second interior surface disposed opposite a second exterior surface. The first elongated member and second elongated member having an arcuate shape towards a communal center, such that each tiered magnet is configured to affix to one another in an annular configuration. In this way, a user is able to magnetically affix the tiered magnet modular collar around a garbage disposal to catch metallic objects inserted therein.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the tiered magnet modular collar.

FIG. 1B shows a perspective view of an embodiment of a tiered magnet.

FIG. 2A shows a perspective view of an embodiment of the tiered magnet modular collar in a distally attached configuration.

FIG. 2B shows a perspective view of an embodiment of the tiered magnet modular collar in a proximally attached configuration.

FIG. 3A shows a perspective view of an embodiment of the tiered magnet modular collar attaching around a garbage disposal.

FIG. 3B shows a perspective view of an embodiment of the tiered magnet modular collar removably affixed to a garbage disposal.

FIG. 4 shows a perspective view of an embodiment of the tiered magnet modular collar in use.

### DETAILED DESCRIPTION OF THE INVENTION

Reference is made herein to the attached drawings. Like reference numerals are used throughout the drawings to depict like or similar elements of the tiered magnet modular collar. The figures are intended for representative purposes only and should not be considered to be limiting in any respect.

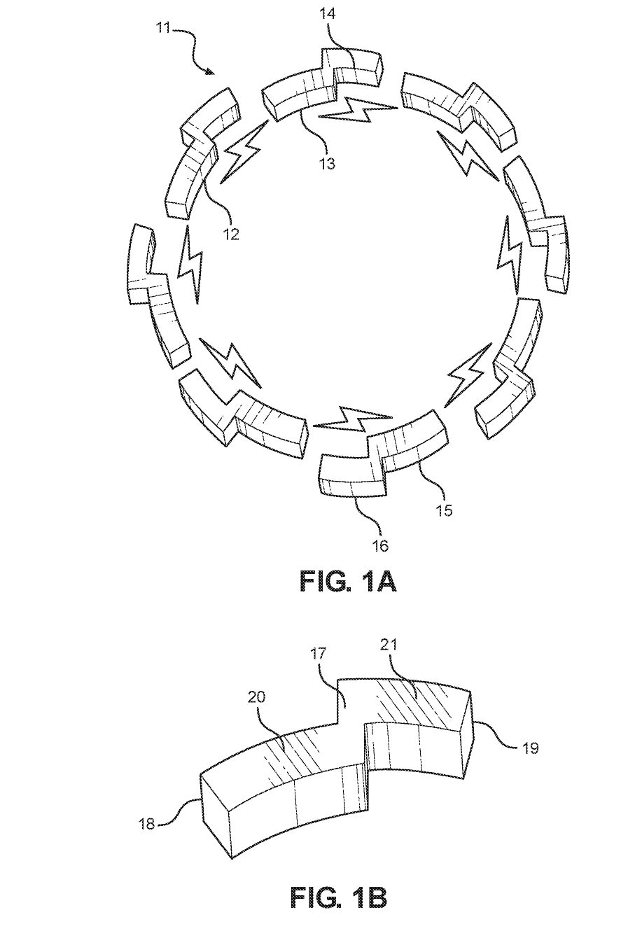

Referring now to FIGS. 1A and 1B, there are shown perspective views of an embodiment of the tiered magnet modular collar and the tiered magnet, respectively. The tiered magnet modular collar 11 comprises a plurality of tiered magnets 12 removably secured to one another. Each tiered magnet 12 comprises a first elongated member 20 and a second elongated member 21. As is traditional for magnets, the tiered magnet 12 has a north pole disposed opposite a south pole. In the illustrated embodiment, the north pole is disposed at a far end of the first elongated member 20 on a first distal end 18, whereas the south pole is disposed at a far end of the second elongated member 21 on a second distal end 19.

The first elongated member 20 includes a first interior 13 disposed opposite a first exterior 15. Similarly, the second elongated member 21 includes a second interior 14 disposed opposite a second exterior 16. In the shown embodiment, the first interior 13 and the second interior 14 extend parallel to one another, while the first exterior 15 and second exterior 16 extend parallel to one another. Both the first elongated member 20 and the second elongated member 21 have an arcuate shape, such that the first and second interiors 13, 14 are both concave. In the shown embodiment, the arcuate shape of the first elongated member 20 and the arcuate shape of the second elongated member 21 are equivalent to one another. Thus, the first interior 13 has an angle measurement which is equal to an angle measurement of the second interior 14. In other embodiments, however, the degree measurement of the first interior 13 and the second interior 14 differ from one another to provide the user greater amount of control when utilizing the tiered magnet modular collar 11.

In the illustrated embodiment, the first elongated member 20 is positioned such that the second elongated member 21 is offset from the first elongated member 20, such that the second elongated member 21 partially overlaps the first elongated member 20 by a predetermined amount but does not completely overlap the first elongated member 20. In the shown embodiment, the first elongated member 20 is permanently affixed to the second elongated member 21 at a predetermined optimal ratio, thereby ensuring the user does not need to worry regarding the efficacy of the tiered magnet modular collar 11. However, in other embodiments wherein the user desires a greater degree of control over the workings of the tiered magnet modular collar 11, the first elongated member 20 can be separated from the second elongated member 21 such that user can control the amount of overlap between the first elongated member 20 and the second elongated member 21.

The first elongated member 20 is operably connected to the second elongated member 21 via a connecting bar 17. The connecting bar 17 is disposed therebetween the first elongated member 20 and the second elongated member 21, such that the connecting bar 17 is oriented perpendicular to the first elongated member 20 and the second elongated member 21. Thus, the connecting bar 17 is positioned at a proximal end of the first elongated member 20 and a proximal end of the second elongated member 21. In the illustrated embodiment, the connecting bar 17 is dimensioned such that the first elongated member 20 is flush against the second elongated member 21. However, in other embodiments, the connecting bar 17 is dimensioned to space the first elongated member 20 at a distance away from the second elongated member 21. In the shown embodiment, the connecting bar 17 is linear, such that the connecting bar 17 extends in a straight line between the first elongated member 20 and the second elongated member 21.

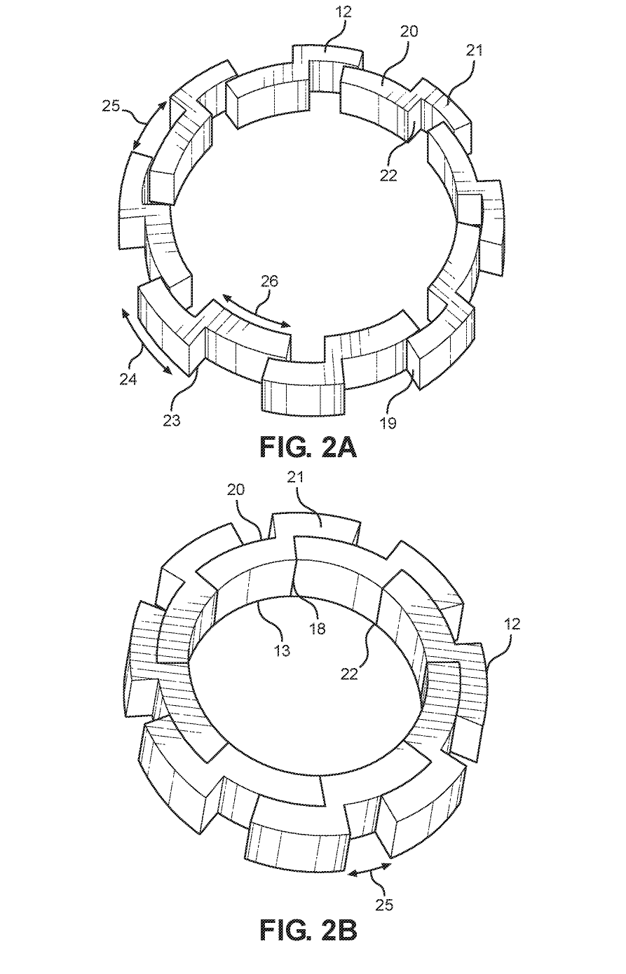

Referring now to FIGS. 2A and 2B, there are shown perspective views of an embodiment of the tiered magnet modular collar in attached configurations. Each tiered magnet 12 includes a first proximal end 22 and a second proximal end 23, wherein the first proximal end 22 is disposed on the first elongated member 20 opposite the first distal end 18, and the second proximal end 23 is disposed on the second elongated member 21 opposite the second distal end 19.

The first elongated member 20 has a first length 26, wherein the first length 26 is the distance between the first distal end 18 and the first proximal end 22. Similarly, the second elongated member 21 has a second length 24, wherein the second length 24 is defined as the distance between the second distal end 19 and the second proximal end 23.

The tiered magnets 12 are configured to removably secure to one another in an annular configuration, such that the first distal end 18 of one magnet is disposed proximate to the second distal end 19 of another magnet. As the first distal end 18 includes a force of opposing polarity to the second distal end 19, in this way one tiered magnet 12 is configured to removably secure to another tiered magnet 12 when oriented appropriately.

In the embodiment illustrated in FIG. 2A, the plurality of tiered magnets 12 are attached to one another in a distally attached configuration. In the distally attached configuration, the first distal end 18 of one tiered magnet 12 is positioned proximate to the second distal end 19 of a different tiered magnet 12, such that the first and second elongated members 20, 21 of one tiered magnet 12 are aligned with the first and second elongated members 20, 21 of the proximately attached tiered magnet 12. In the shown embodiment FIG. 2A, the second elongated member 21 is positioned to overlap the first elongated member 20 an equivalent distance on either end.

In the embodiment illustrated in FIG. 2B, the plurality of tiered magnets 12 are attached to one another in a proximally attached configuration. In the proximally attached configuration, the first distal end 18 of one tiered magnet 12 is positioned flush against the first proximal end 22 of another tiered magnet 12, such that each tiered magnet 12 is contiguous to one another. In this way, the first interior 13 of each tiered magnet 12 forms a continuous annular circumference.

In the attached configuration, such that the tiered magnets 12 are joined to one another, a gap 25 is formed therebetween the two second elongated members 21. The length of the gap 25 is measured as the distance between the second distal end 19 and the second proximal end 23. Thus, the gap 25 measures a greater length in a distally attached configuration than the gap 25 measured in the proximally attached configuration.

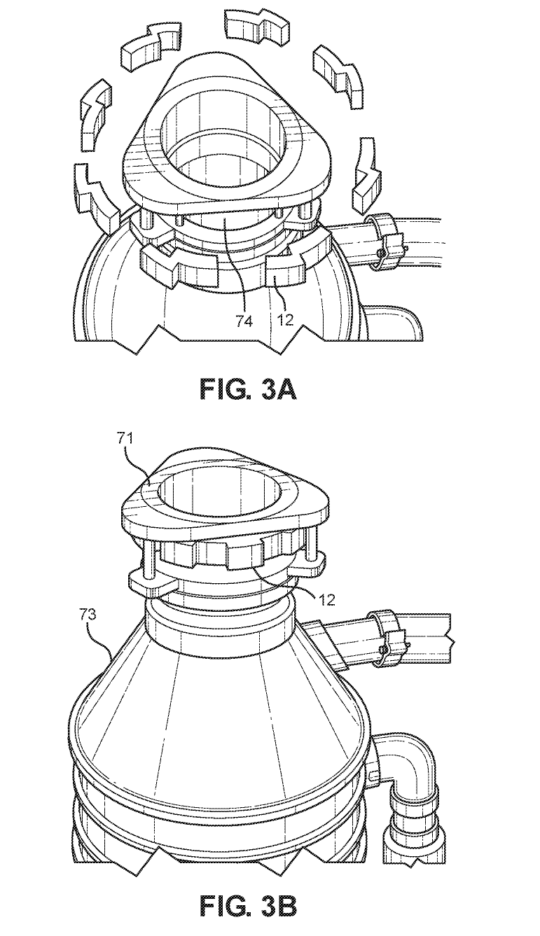

Referring now to FIGS. 3A and 3B, there are shown perspective views of an embodiment of tiered magnet modular collar attaching to and attached to a garbage disposal system, respectively. The arcuate shape of the first interior of the first elongated member allows the user to position each tiered magnet 12 flush against a neck 74 of a garbage disposal 73. As each tiered magnet 12 is positioned in the annularly attached configuration, the second interior of the second elongated member is oriented flush against the first exterior of the first elongated member of the next tiered magnet 12. Thus, the plurality of tiered magnets 12 form an unbroken circle surrounding the neck 74 of the garbage disposal 73.

The tiered magnet modular collar is positioned below the mouth 71 of the garbage disposal 73, such that any metallic items, such as an eating utensil, which may accidentally fall into the mouth 71 are attracted to the tiered magnets 12. Thus, the tiered magnet modular collar prevents the utensil from being caught in the garbage disposal 73, thereby preserving the quality of the utensil and protecting the user.

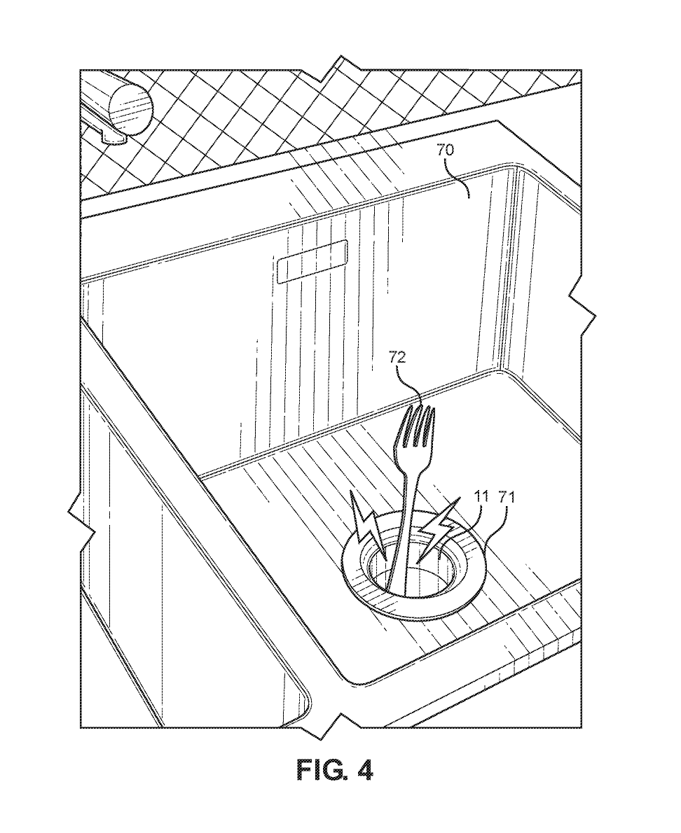

Referring now to FIG. 4, there is shown a perspective view of an embodiment of the tiered magnet modular collar in use. In operation, a user having a sink 70 with a garbage disposal disposed therein, will examine the neck of the garbage disposal positioned beneath the sink 70. The user, desiring to prevent loose utensils 72 from falling into the garbage disposal, will position the tiered magnet modular collar 11 therearound the neck. The user will position each tiered magnet around the neck such that the concave first interior is flush against the neck, and the concave second interior is flush against the first exterior of the tiered magnet positioned proximate thereto. Thus, any utensil 72 which enters the mouth 71 of the garbage disposal is caught by the tiered magnet modular collar. In this way, the tiered magnetic modular collar 11 assists the user with catching metallic objects inserted into the garbage disposal.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1) A tiered magnet modular collar, comprising:
a plurality of tiered magnets;
each tiered magnet comprising a first elongated member offset from a second elongated member;
wherein the first elongated member is affixed to the second elongated member via a connecting bar disposed perpendicular therebetween;
the first elongated member having a first distal end opposite a first proximal end with a first interior surface disposed opposite a first exterior surface;
the second elongated member having a second distal end opposite a second proximal end with a second interior surface disposed opposite a second exterior surface;
the first elongated member and second elongated member having an arcuate shape towards a communal center;
wherein each tiered magnet is configured to affix to one another.

2) The tiered magnet modular collar of claim 1, wherein each tiered magnet is dimensioned equivalent to one another.

3) The tiered magnet modular collar of claim 1, wherein a measured arc of the first elongated member is equal to a measured arc of the second elongated member.

4) The tiered magnet modular collar of claim 1, wherein the first exterior of the first elongated member is permanently affixed flush against the second interior of the second elongated member.

5) The tiered magnet modular collar of claim 1, wherein a length of the first elongated member is equal to a length of the second elongated member.

6) The tiered magnet modular collar of claim 1, wherein the connecting bar is linear.
